(19) United States
(12) Patent Application Publication
(10) Pub. No.: US 2020/0324633 A1
(43) Pub. Date: Oct. 15, 2020

(54) TONNEAU COVER LATCH AND SIDE RAIL SYSTEM

(71) Applicants: Hang Shi, Changzhou (CN); Hongjuan Zheng, Changzhou (CN)

(72) Inventors: Hang Shi, Changzhou (CN); Hongjuan Zheng, Changzhou (CN)

(73) Assignee: Changzhou Sunwood International Trading Co. Ltd., Changzhou (CN)

(21) Appl. No.: 16/847,635

(22) Filed: Apr. 13, 2020

Related U.S. Application Data
(60) Provisional application No. 62/863,927, filed on Jun. 20, 2019.

(30) Foreign Application Priority Data
Apr. 12, 2019 (CN) 2019102920580
Apr. 12, 2019 (CN) 2019204907321

(51) Int. Cl. B60J 7/19; B60J 7/00

(52) U.S. Cl. CPC B60J 7/198; E05B 83/16; B60J 7/0084

(57) ABSTRACT

The present disclosure describes a tonneau cover support system for a cargo bed of a truck. The tonneau cover support system includes a tonneau cover for covering the cargo bed, a plurality of side rails to support the tonneau cover when the tonneau cover is in a closed position, and a plurality of clamp assemblies for securing the plurality of side rails to side walls of the cargo bed. Each of the plurality of clamp assemblies is slid and mounted onto one of the plurality of side rails. The tonneau cover support system further includes a latch assembly having a latch and a plunger section. The latch is configured to be slid and mounted onto one of the plurality of side rails, and the plunger section is installed on the tonneau cover.

### CROSS REFERENCE TO RELATED APPLICATIONS

The present application is related to and claims the benefits of priority of the following commonly-owned, presently-pending applications: a U.S. provisional application with an application No. 62/863,927, filed on Jun. 10, 2019, entitled “Tonneau Cover Latch and Side Rail System”; Chinese applications with application serial no. 2019102920580 and application serial no. 2019204907321, both of which filed on Apr. 12, 2019, entitled “Tonneau Cover Locking Device, Cargo Bed and Truck”, of which the present application is a non-provisional application thereof. The disclosures of the forgoing applications are hereby incorporated by reference in them entirely, including any appendices or attachments thereof, for all purposes.

### BACKGROUND

Unless otherwise indicated herein, the approaches described in this section are not prior art to the claims in this application and are not admitted to be prior art by inclusion in this section.

Cargo bed covers have been used to cover the cargo beds of pickup trucks and protect cargo bed interior against dirt, debris and other environmental contaminants. In some cases, cargo bed covers are also used to improve the aesthetic quality of the pickup trucks. Conventional covers were designed by upholstery shops and typically have two side rails, each side rail includes a latch and a folding cover supported on the side rail. A plunger in the latch reaches into the side rail, such that the folding cover is prevented from being raised through the limiting function of the side rail in the vertical direction. Unfortunately the plunger will contact and collide with the side rail, and the side rail is easily damaged after a long time of use. In addition, the latch can only limit the folding cover in the vertical direction, and cannot limit the folding cover in the horizontal direction.

### SUMMARY OF THE PRESENT DISCLOSURE

The present disclosure describes a tonneau cover support system for a cargo bed of a truck. The tonneau cover support system includes a tonneau cover for covering the cargo bed, a plurality of side rails to support the tonneau cover when the tonneau cover is in a closed position, and a plurality of clamp assemblies for securing the plurality of side rails to side walls of the cargo bed. Each of the plurality of clamp assemblies is slid and mounted onto one of the plurality of side rails. The tonneau cover support system further includes a latch assembly having a latch and a plunger section. The latch is configured to be slid and mounted onto one of the plurality of side rails, and the plunger section is installed on the tonneau cover.

### BRIEF DESCRIPTION OF THE DRAWINGS

The foregoing and other features of the present disclosure will become more fully apparent from the following description and appended claims, taken in conjunction with the accompanying drawings. These drawings depict only several embodiments in accordance with the disclosure and are, therefore, not to be considered limiting of its scope. The disclosure will be described with additional specificity and detail through use of the accompanying drawings.

FIG. 1 illustrates a tonneau cover with a supporting system for a pickup truck,;

FIG. 2 illustrates an enlarged view of a portion A of FIG. 1;

FIG. 3 illustrates an enlarged view of a portion B of FIG. 1;

FIG. 4 illustrates a cross-sectional view of the tonneau cover supporting system mounted on a side wall of a cargo bed;

FIG. 5 illustrates a perspective view of a side rail with a clamp assembly;

FIG. 6 illustrates a cross sectional view of a side rail installed with a latch;

FIG. 7 illustrates a cross sectional view of a side rail operating with a latch assembly; and

FIG. 8 illustrates a prospective view of a side rail operating with a latch assembly, all according to certain embodiments of the present disclosure.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and make part of this disclosure.

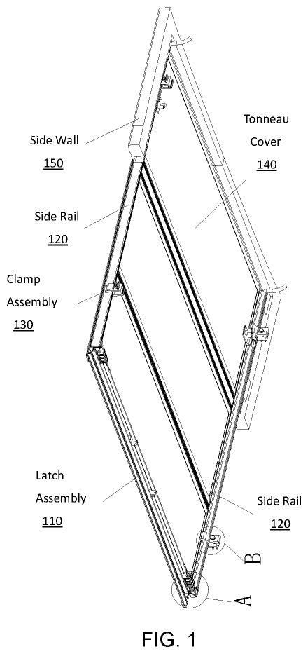

FIG. 1 illustrates a tonneau cover with a supporting system for a pickup truck, according of certain embodiments of the present disclosure. In FIG. 1, a tonneau cover supporting system may be used to allow a tonneau cover 140 to be securely placed on the top of a cargo bed of the pickup truck. The tonneau cover supporting system may include two side rails 120 that can be disposed on the two side walls 150 of the cargo bed. The tonneau cover supporting system may also include a latch assembly 110 for locking the tonneau cover 140 onto the side rails 120, and multiple clamp assemblies 130 for connecting the side rails 120 to the side walls 150 of the cargo bed.

In some embodiments, the tonneau cover 140 may be used to cover the cargo bed of a pickup truck. The pickup truck may be any vehicle having an opened/exposed cargo bed in its back. The cargo bed may include a front wall, a left-side wall, a right-side wall, as well as a tailgate (or back wall). The left-side wall, the right-side wall, and/or the tailgate may be individually and selectively opened or closed. The front wall, the left-side wall, the right-side wall, and tailgate may be individually referred to as a “side wall”, and may be constructed using metal sheets rolled or jointed together, forming long, narrow, and relatively flat surfaces on the top of these walls. The tonneau cover 140 may be placed on, attached to, or supported by, the top flat surfaces of these walls, and may protect the inner space of the pickup truck's cargo bed from adverse weather, potential theft, or cargo-dislodging when the pickup truck is stationary or in motion. The tonneau cover 140 may also be used to cover the interior space of any transportation device, whether powered or not, to cover any opened compartment; or to cover any physical structure having an opening.

For clarification purposes, once the tonneau cover 140 is installed onto the pickup truck's cargo bed, the side of tonneau cover 140 designed to face inside/interior of the cargo bed (or face down when installed and closed on the cargo bed) may be referred to as the “bottom” or “inner” side of the tonneau cover 140, and the other side of the tonneau cover 140 designed to face outside/exterior of the cargo bed (or face up when installed and closed on the cargo bed) may be referred to as the “top” or “outer” side of the tonneau cover 140. Further, various hinges and clamps of the tonneau cover 140 shown in FIG. 1 are for illustrative purposes. These hinges and clamps are located on the inner side of the tonneau cover 140, and should be hidden from external views when the tonneau cover 140 covers the cargo bed.

In some embodiments, the tonneau cover 140 may have multiple panels each of which may be opened or closed. For clarification purposes, when the panels are covering the cargo bed, the tonneau cover 140 may be referred to as in a “closed” position. In some embodiments, one panel may be “opened” to expose part of the cargo bed previously covered by the panel. In some embodiments, some of the panels may be equipped with one or more assemblies (e.g., latch assembly 110) to securely cover the cargo bed when these panels are in a closed position.

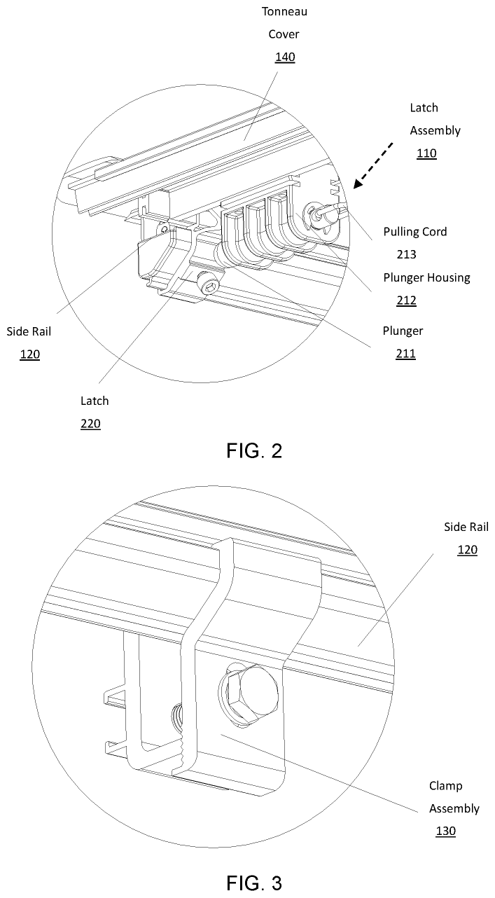

FIG. 2 illustrates a perspective view of a latch assembly latching to a tonneau cover supporting system, according of certain embodiments of the present disclosure. The FIG. 2 is an enlarged view of the Circle A of FIG. 1. In FIG. 2, the tonneau cover 140 may be in a closed position, and may be situated above one of the side rails 120. The side rail 120 may be placed on the top of a side wall (not shown in FIG. 2) of a cargo bed. The bottom surface of the tonneau cover 140 may be installed with a plunger portion of a latch assembly 110. The latch assembly 110 may also include a latch 220 mounted onto the side rail 120.

In some embodiments, the plunger portion of the latch assembly 110 may include a plunger 211, a plunger housing 212 for holding the plunger 211, a pulling cord 213 that is attached to the plunger 211, and a spring mechanism (not shown in FIG. 2) inside of the plunger housing 212. One end of the plunger 211 may be pushed out of the plunger housing 211 by the spring. A pulling cord 213 may pull the plunger 211 horizontally along the longitude of the plunger housing 211, which in turn may retract the plunger 211 into the plunger housing 211 (“retracted position”). A push of the plunger 211 may also force the plunger 211 into the retracted position. When the pulling cord 213 is released, the spring mechanism may push and move the plunger 211 horizontally in opposite direction, which may extend the one end of the plunger 211 out of the plunger housing 212 (“extended position”), as long as no external retracting force is applied to the plunger 211.

In some embodiments, the latch 220 may be slid into the side rail 120 and detachably mounted on the side rail 120 at a location that can block the plunger 211 when it is in the extended position. When the pulling cord 213 is not pulled, the plunger 211 may be extended so that it is blocked by the latch 220, and the tonneau cover 140 may be locked since the latch 220 may prevent the plunger 211, as well as the tonneau cover 140, from substantial movement (thus not opened). When the pulling cord 213 is pulled, the plunger 211 may be in the retracted position. In this case, the latch 220 can no longer block the plunger 211, and the tonneau cover 140 may be opened.

FIG. 3 illustrates a perspective view of a clamp assembly mounted to a side rail, according of certain embodiments of the present disclosure. The FIG. 3 is an enlarged view of the Circle B of FIG. 1. In FIG. 3, the clamp assembly 130 may be used to securely attach the side rails 120 to a side wall (not shown in FIG. 2) of a cargo bed. And multiple clamp assemblies 130 may be needed to clamp the side rail 120 onto the side wall. The clamp assembly 130 may have two clamping blocks (an inner clamping block and an outer clamping block), and a fixing component (e.g., bolt) that connects these two clamping blocks. The details of the claim assembly 130 may be further described below.

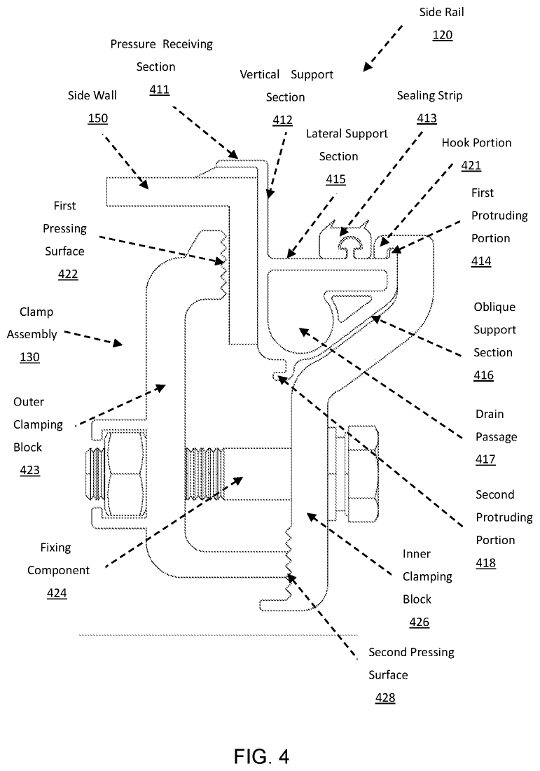

FIG. 4 illustrates a cross-sectional view of the tonneau cover supporting system mounted on a side wall of a cargo bed, according of certain embodiments of the present disclosure. In FIG. 4, a side rail 120 may be securely attached to the side wall 150 of the cargo bed via a clamp assembly 130. The side rail 120 may be a long piece of metal having a pressure receiving section 411, a vertical support section 412, a lateral support section 415, and an oblique support section 416. Even though the cross sectional views of these sections 411, 412, 415, and 416 may be 2-dimensional, these sections follow along the side rail 120, forming channel-line structures. The side wall 150 may be a piece of metal bent into certain shape and with certain thickness as shown in FIG. 4. The vertical support section 412 may be closely in contact with a vertical surface of the side wall 150, and the upper portion of the vertical support section 412 may be attached to the pressure receiving section 411, which may extend above and be positioned on the top of the side wall 150. The pressure receiving section 411 may be used to support the weight of the side rail 120 and the tonneau cover when in a closed position.

In some embodiments, the lower portion of the vertical support section 412 may be connected with the lateral support section 415 and the oblique support section 416. The lateral support section 415 may be substantially horizontal to support the bottom surface of the tonneau cover. In other words, the vertical support section 412 may perpendicularly (substantially in 90 degrees) extend above and below the lateral support section 415. The bottom surface (the surface that faces down) of the tonneau cover may have one of its edges in contact with the lateral support section 415 when the tonneau cover is in a closed position. And the weight of the tonneau cover may be transferred first to the lateral support section 415, then to the vertical support section 412, and finally to the side wall 150 via the pressure receiving section 411.

In some embodiments, the oblique support section 416 may have one side connected with the lateral support section 415, and the other side connected with the lower end of the vertical support section 412. Specifically, the oblique support section 416 may be inclined/tilted or partially inclined/tilted to a certain degree (between 20 degrees and 70 degrees) from the perspective of the vertical support section 412 or the lateral support section 415. Thus, the vertical support section 412, the lateral support section 415, and the oblique support section 416 may surround and form a substantially triangular shape, which may provide a more rigid and sturdy structure for the side rail 120, especially in comparison to a side rail with a rectangular shaped cross section.

In some embodiments, the triangular shape may lower the weight of the side rail 120 while maintaining structure integrity. Inner space of the triangular shape may be used for water drainage. Additional structure may be placed inside of the triangular shape to provide structure support, as shown in FIG. 4. Further, the two edges of the oblique support section 416, which are connected with the lateral support section 415 and the vertical support section 412 respectively, may have a more or less round or curving shape to allow smooth transitions among the different sections. The oblique support section 416 may be used to mount the latch 220 and/or the clamp assembly 130.

In some embodiments, a clamp assembly 130 may be used to securely attach the side rail 120 to the side wall 150 of the cargo bed. The clamp assembly 130 may include an inner clamping block 426, an outer clamping block 423, and a fixing component 424 to bond the inner clamping block 426 with the outer clamping block 423. The inner clamping block 426 may have a turned shape conforming to the external surface shape of the side rail 120. In other words, the shape of the top half of the inner clamping block 426 may closely follow the external surface shape of the oblique support section 426. The outer clamping block 426 may have a substantially L shape with a first end having a first pressing surface 422.

In some embodiments, the first end of the inner clamping block 426 may have a hook portion 421 that can hook onto a first protruding portion 414 that is located on the edge of the lateral support section 415. The hook portion 421 may be extended throughout the longitude of the side rail, in order to allow the inner clamping block 426 to grab hold of the side rail 120 at any location. Alternatively, the hook portion 421 may be present in certain strategic positions (e.g., front, middle, or back) on the side rail 120. The first end of the outer clamping block 423 may have a first pressing surface 422 with rough teeth that can grab onto the side wall 150 using friction. Thus, one side of the side wall 150 may be in contact with the first pressing surface 422, and the other side of the side wall 150 may be in contact with the vertical support section 412. Further, the second end of the inner clamping block 426 may have a second pressing surface 428 with rough teeth (zigzag or frosted shape). When the second end of the outer clamping block 423 is in contact with the second end of the inner clamping block 426, the second pressing surface 428 may provide friction to allow both ends to be securely connected.

In some embodiments, the inner clamping block 426 and the outer clamping block 423 may have corresponding holes that allow the fixing component 424 to pass through. The fixing component 424 may be a screw with nut (located in a nut compartment as shown in FIG. 4) or a clamp that can secure the inner clamping block 426 with the outer clamping block 423. When secured, a second end of the inner clamping block 426 and a second end of the outer clamping block 423 may be in contact. Thus, when the fixing component 424 is tightened, its force may press the two blocks 423 and 426 to be closely against each other. This force may also press the side rail 120 against the side wall 150, thereby securing the side rail 120 on the side wall 150. This force may further prevent any movements between the two blocks 423 and 426 due to the frictions on the first pressing surface 422 and the second pressing surface 428.

In some embodiments, the side rail 120 may have a sealing strip 413 positioned on the top surface of the lateral support section 415 and extending along the longitude of the side rail 120. When the tonneau cover is closed above the lateral support section 415, the sealing strip 413, which may be in contact with the bottom surface of the tonneau cover, thereby forming a tight seal that prevents external water or moist from entering into the cargo bed. Alternatively, the tonneau cover may be placed on, attached to, or supported by, the pressure receiving section 411, and may protect the inner space of the pickup truck's cargo bed from adverse weather, potential theft, or cargo-dislodging when the pickup truck is stationary or in motion.

FIG. 4 further shows the vertical support section 412, the oblique support section 416, and the lateral support section 415 surround to form a drain channel 417 for discharging any water entering through the tonneau cover, the pressure receiving section 411, and/or the lateral support section 415. Specifically, multiple drain holes on the side rail 120 may allow water to enter into the drain channel 417, which is extended throughout the longitude of the side rail 120. The water may then flow to one end of the drain channel 417, and a tube that is attached to this one end of the drain channel 417 may then allow the water to flow out of the cargo bed.

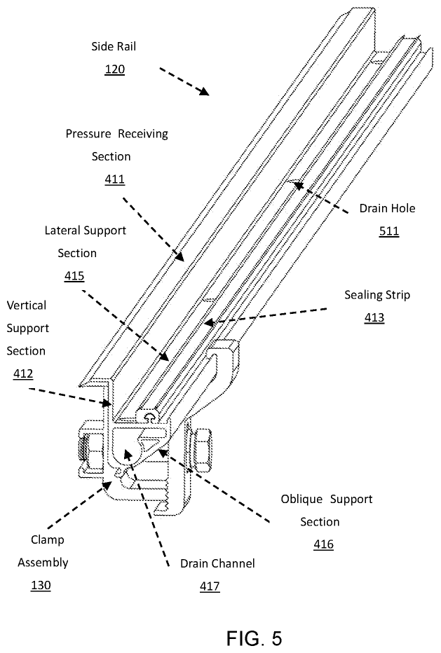

FIG. 5 illustrates a perspective view of a side rail with a clamp assembly, according of certain embodiments of the present disclosure. In FIG. 5, multiple drain holes 511 may be evenly positioned on the top surface of the lateral support section 415. External water or moist flow down the pressure receiving section 411 or the vertical support surface 412, and may be gathered on the lateral support section 415. The water may enter through the drain holes 511 and into the drain channel 417. Further, the lateral support section 415 is installed with a sealing strip 413 extending from one end of the side rail 120 to its other end. When the tonneau cover is supported on the pressure receiving surface 411, the lower surface of the tonneau cover may be tightly pressed against the sealing strip 413 to form a sealed interior in the cargo bed.

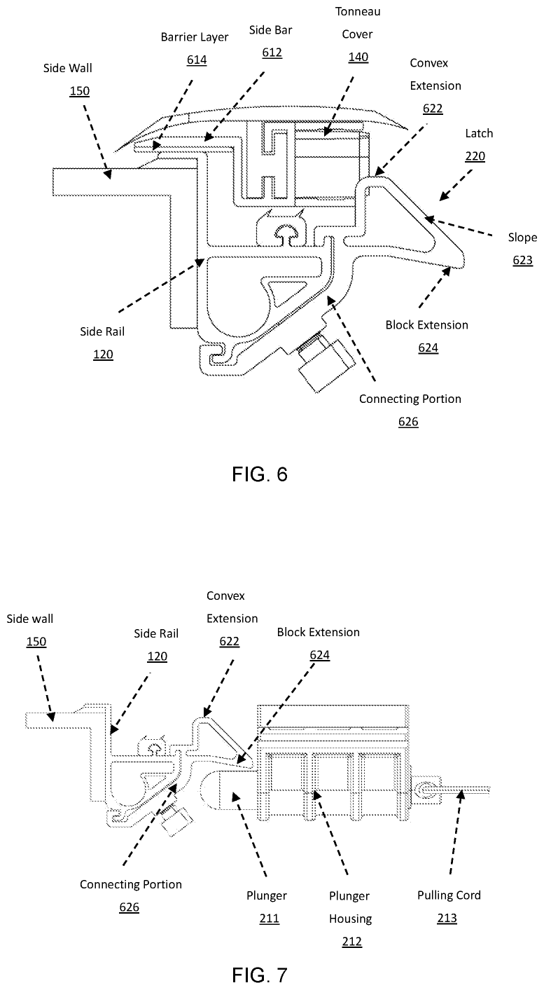

FIG. 6 illustrates a cross sectional view of a side rail installed with a latch, according of certain embodiments of the present disclosure. In FIG. 6, a side rail 120 may be installed onto a side wall 150 of a cargo bed using clamp assembly as described above. The side rail 120 may further be installed with a latch 220, which may be used as a part of hinge assembly as shown below. The latch 220 may have a connecting portion 626, a convex extension 622, a slope 623, and a block extension 624. An edge of the tonneau cover 140 may have a side bar 612, which can extend over and cover the pressure receiving section 411 of the side rail 120 when the tonneau cover 140 is in a closed position.

In some embodiments, the side bar 612 may have a barrier layer 614 contacting the pressure receiving section 411, and the pressure receiving surface 411 supports the tonneau cover 140 through the side bar 612. The barrier layer 614 may be made of flexible material such as plastic or rubber, so that the tonneau cover 140 would not knock on the side rail 120 or make noise during movement. The barrier layer 614 may also prevent/reduce water and debris from entering the inner space of the cargo bed. In some embodiments, the shape of the connecting portion 626 is fitted to the shape of the oblique support section 416, in a similar fashion as the shape of the inner clamping block 426 is fitted to the shape of the oblique support section 416.

In some embodiments, the connecting portion 626 may have two hooks on its two edges (similar to the hook portion 421 of the clamp assembly) that can hook onto the first protruding portion 414 and the second protruding portion 418 of the side rail 120. Specifically, the first protruding portion 414 and the second protruding portion 418 may extend along the longitude of the side rail 120. These two hooks may allow the latch 220 to slide into position through one end of the side rail 120. The connecting portion 626 is also equipped with a tightening screw to secure the latch 220 onto the side rail 120 at any location. Once secured, the latch 220 will no longer move along the side rail 120. The block extension 624 may be used to block a plunger. The convex extension 622 may be used to block or maintain the tonneau cover 140. And the slope 623 may push a plunger into retracted position when the tonneau cover is closing.

FIG. 7 illustrates a cross sectional view of a side rail operating with a latch assembly, according of certain embodiments of the present disclosure. In FIG. 7, the latch assembly may include a latch 220 and a plunger section. The latch 220 may be attached to a side rail 120, which may be secured to a side wall 150 of a cargo bed. The plunger section of the latch assembly may include the plunger 211, the plunger housing 212, and the pulling cord 213. The plunger housing 212 may be installed on the bottom surface of the tonneau cover. When the tonneau cover is closed, the plunger section may act as a lock to shut the tonneau cover. In other words, the plunger 211 may serve as a lock bolt, which may slide in and out of the plunger housing 212 either using external pressure or via the pulling cord.

In some embodiments, the plunger section of the latch assembly may be installed along one edge of the tonneau cover toward the back of the truck. Based on the location of the plunger section, the latch 220 may be installed on the side rail 120 at a location that when the tonneau cover is closed, the plunger 211 will meet the latch 220. To close the tonneau cover, one can lower the tonneau cover until the plunger 211 hit the slope 623 of the connecting portion 626. The weight of the tonneau cover may transfer to an external push force applied to the plunger 211 by the slope 623, forcing the plunger 211 into a retracted position. Once retracted, the block extension can no longer block the plunger 211, and the tonneau cover can be rested on the top the side rail 120. As soon as the plunger 211 passes the block extension 624, no more external force applies to the plunger 211, and the plunger 211 may be restored to an extended position. In the extended position, the plunger 211 may be located below the block extension 624, thereby preventing the tonneau cover from being opened.

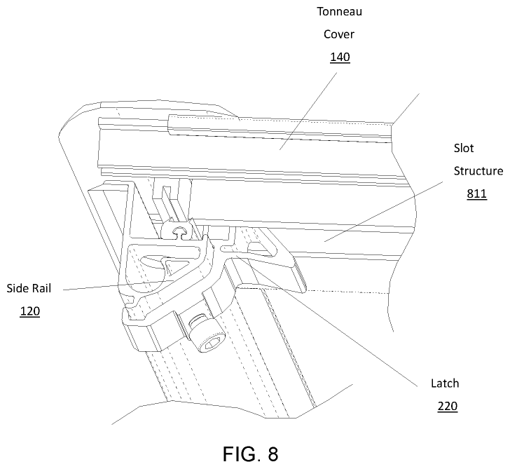

FIG. 8 illustrates a prospective view of a side rail operating with a latch assembly, according of certain embodiments of the present disclosure. In FIG. 8, a latch 220 may be attached to a side rail 120, which may be secured to a side wall of a cargo bed. A tonneau cover 140 may be in a closed position and may be supported by the side rail 120. The bottom of the tonneau cover 140 may include a slot structure 811, which may be formed by two parallel side walls extending out of the bottom surface of the tonneau cover 140. The width of the slot structure 811 may be larger than the width of the latch 220, so that the convex extension 622 of the latch 220 may get between the two side walls and inserted into the slot structure 811. The slot structure 811 may be long across from one edge to the opposite edge of the tonneau cover 140. The slot structure 811 may also be a “hole” that is surrounded by multiple walls, as long as the latch 220 may be inserted into the hole.

In some embodiments, when the tonneau cover 140 is closed, the two side walls of the slot structure 811 may prevent the latch 220 from moving/sliding sideway along the side rail 120. In this case, even if the latch 220 becomes loose, it will not move out of its intended position so that its block extension cannot block the plunger 211 and allow the tonneau cover 140 to be unintentionally opened. The latch 220 in the slot structure 811 may also prevent the tonneau cover 140 from shaking in the front-rear direction. When the slot structure 811 is a hole or groove, the latch 220 inserted in the slot structure 811 may also prevent the tonneau cover 140 moving in the front-rear direction and the left-right direction.

In some embodiments, the block extension 624 may have its tip curved toward the plunger 211, such that there is only a minimum contact between the block extension 624 and the plunger 211, and the outermost end of the plunger 211 is not in contact with the latch 220. Such an approach may prevent the plunger 211 from continuous colliding and damaging the latch 220 during vehicle movement. Further, the plunger 211 shall not extend to much into the latch 220 so that the plunger 211 may collide with the connecting portion of the latch 220.

In some embodiments, when locking the tonneau cover, a user may first pull the pulling cord 213 to retract the plunger 211, and then place the tonneau cover 140 on the cargo bed 150 using supports from the pressure receiving surface 411. Once the position of the plunger 211 is lower than the latch 220's, the user may release the pulling cord 213, allowing the plunger 211 to extend and move below the block extension 624. Optionally, with the installation of a lock, the pulling cord 213 cannot be pulled without a key to the lock, and the block extension 624 may block the plunger 211 and prevent the tonneau cover 140 from being opened.

In some embodiments, the convex extension 622 reaches into the slot structure of the tonneau cover 140 to prevent the tonneau cover 140 from shaking during vehicle movement. In case of heavy rain or the like, water may enter the side rail 120 through gaps between the tonneau cover 140 and the pressure receiving surface 411. The water may be discharged through drain holes 511 on the later support section 415 and into the drain channel 417 to discharge through the through holes 511 on the lateral support section 415. The sealing strip 413 may also prevent water from entering the interior of the cargo bed 150.

Thus, multiple embodiments of a tonneau cover support system for a pickup truck have been described. Although the present disclosure has been described with reference to specific exemplary embodiments, it will be recognized that the disclosure is not limited to the embodiments described, but can be practiced with modification and alteration within the spirit and scope of the appended claims. Accordingly, the specification and drawings are to be regarded in an illustrative sense rather than a restrictive sense.

One skilled in the art will appreciate that, for this and other apparatuses and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments. Moreover, one or more of the outlined steps and operations may be performed in parallel.

We claim:

1. A tonneau cover support system for a cargo bed or a truck, comprising:
a plurality of side rails configured to be secured to side walls of the cargo bed, wherein each of the plurality of side rails includes
a lateral support section for supporting a tonneau cover,
a vertical support section connecting to the lateral support section and perpendicularly extending above and below the lateral support section, wherein the vertical support section is configured to be in contact with a corresponding side wall of the cargo bed,
an oblique support section connecting to the vertical support section and the lateral support section, and
a drain channel formed by the vertical support section, the lateral support section, and the oblique support section,
wherein each of the plurality of side rails is configured for mounting a clamp assembly or a latch assembly.

2. The tonneau cover support system of claim 1, further comprising:
the clamp assembly, wherein the clamp assembly contains an inner clamping block, an outer clamping block, and a fixing component for connecting the inner clamping block and the outer clamping block.

3. The tonneau cover support system of claim 2, wherein the inner clamping block is configured to hook onto the lateral support section of one of the plurality of side rails.

4. The tonneau cover support system of claim 2, wherein the outer clamping block is configured to grab onto one of the side walls of the cargo bed.

5. The tonneau cover support system of claim 1, further comprising:
the latch assembly, wherein the latch assembly contains a latch for mounting to one of the plurality of side rails, and a plunger section installed on the tonneau cover.

6. The tonneau cover support system of claim 5, wherein the plunger section comprises a plunger, a plunger housing, and a pulling cord.

7. The tonneau cover support system of claim 6, wherein when the plunger is in an extended position, the latch blocks the plunger and prevents the tonneau cover from being opened.

8. The tonneau cover support system of claim 1, wherein the tonneau cover is supported by the plurality of side rails and not in contact with the side walls.

9. The tonneau cover support system of claim 1, with the lateral support section contains a drain opening allowing water to pass through and enter the drain channel.

10. A tonneau cover support system for a cargo bed of a truck, comprising:
a tonneau cover for covering the cargo bed;
a plurality of side rails configured to support the tonneau cover when the tonneau cover is in a closed position;
a plurality of clamp assemblies for securing the plurality of side rails to side walls of the cargo bed, wherein each of the plurality of clamp assemblies is slid and mounted onto one of the plurality of side rails; and
a latch assembly including a latch and a plunger section, wherein the latch is configured to be slid and mounted onto one of the plurality of side rails, and the plunger section is installed on the tonneau cover.

11. The tonneau cover support system of claim 10, wherein each of the plurality of side rails comprises:
a lateral support section for supporting a tonneau cover,
a vertical support section connecting to the lateral support section and perpendicularly extending above and below the lateral support section, wherein the vertical support section is configured to be in contact with a corresponding side wall of the cargo bed, and
an oblique support section connecting to the vertical support section and the lateral support section.

12. The tonneau cover support system of claim 11, wherein each of the plurality of side rails further comprises:
a drain channel formed by the vertical support section, the lateral support section, and the oblique support section,

13. The tonneau cover support system of claim 10, wherein each of the plurality of clamp assemblies comprises:
an inner clamping block, an outer clamping block, and a fixing component for connecting the inner clamping block and the outer clamping block.

14. The tonneau cover support system of claim 10, wherein the plunger section comprises a plunger, a plunger housing, and a pulling cord.

15. The tonneau cover support system of claim 14, wherein when the plunger is in an extended position, the latch blocks the plunger and prevents the tonneau cover from being opened.

16. A tonneau cover support system for a cargo bed of a truck, comprising:
a plurality of side rails configured to support a tonneau cover for covering the cargo bed; and
a plurality of clamp assemblies for securing the plurality of side rails to side walls of the cargo bed, wherein each of the plurality of clamp assemblies is slid and mounted onto one of the plurality of side rails.

17. The tonneau cover support system of claim 16, further comprising:
a latch assembly including a latch and a plunger section, wherein the latch is configured to be slid and mounted onto one of the plurality of side rails, and the plunger section is installed on the tonneau cover.

18. The tonneau cover support system of claim 16, wherein each of the plurality of side rails comprises:
a lateral support section for supporting a tonneau cover,
a vertical support section connecting to the lateral support section and perpendicularly extending above and below the lateral support section, wherein the vertical support section is configured to be in contact with a corresponding side wall of the cargo bed, and
an oblique support section connecting to the vertical support section and the lateral support section.

19. The tonneau cover support system of claim 16, wherein each of the plurality of side rails further comprises:
a drain channel formed by the vertical support section, the lateral support section, and the oblique support section,

20. The tonneau cover support system of claim 10, wherein each of the plurality of clamp assemblies comprises:
an inner clamping block, an outer clamping block, and a fixing component for connecting the inner clamping block and the outer clamping block.
